(19) United States
(12) Patent Application Publication
(10) Pub. No.: US 2026/0125942 A1
(43) Pub. Date: May 7, 2026

(54) POWER DOOR CLOSURE ALGOROTHM FOR TRANSITION FROM NEW TO AGED SEAL PROFILE FOR VEHICLES

(71) Applicant: GM GLOBAL TECHNOLOGY OPERATIONS LLC, Detroit, MI (US)

(72) Inventors: Phillip C. Storck, III, Washington, MI (US); Besi Rrumbullaku, Rochester, MI (US)

(73) Assignee: GM GLOBAL TECHNOLOGY OPERATIONS LLC, Detroit, MI (US)

(21) Appl. No.: 18/939,407

(22) Filed: Nov. 6, 2024

(51) Int. Cl. E05F 15/79; B60J 10/84; E05F 15/659

(52) U.S. Cl. CPC E05F 15/79; B60J 10/84; E05F 15/659; E05Y 2900/531

(57) ABSTRACT

Methods and systems are provided of controlling automatic closing of a door of a vehicle with respect to a seal applied to the vehicle. An input sensor is configured to obtain an input for closing the door. A processor is configured to at least facilitate performing a counter pertaining to an amount of time after which the seal was applied to the vehicle; and upon receiving the input for closing the door: automatically closing the door in accordance with a first protocol with a first driving force, in accordance with instructions provided by the processor, when the counter is less than a predetermined threshold; and automatically closing the door in accordance with a second protocol with a second driving force that is less than the first driving force, in accordance with instructions provided by the processor, when the counter is greater than a predetermined threshold.

### INTRODUCTION

The technical field generally relates to vehicles and, more specifically, to methods and systems for controlling power door closure for vehicles.

Certain vehicles today include power doors (or other opening members) that are automatically opened and closed by the vehicle, for example upon receiving input from a user of the vehicle. In certain situations, the opening of power doors (or other opening members) may be affected when an object is in proximity to the vehicle.

Accordingly, it is desirable to provide improved methods and systems for controlling power doors (and other opening members) of a vehicle, including when an object is in proximity to the vehicle.

### SUMMARY

In accordance with an exemplary embodiment, a method is provided for controlling automatic closing of an opening member of a vehicle with respect to a seal applied to the vehicle, the method including performing a counter, via a processor, pertaining to an amount of time after which the seal was applied to the vehicle; automatically closing the door in accordance with a first protocol with a first driving force, in accordance with instructions provided by the processor, when the counter is less than a predetermined threshold; and automatically closing the door in accordance with a second protocol with a second driving force that is less than the first driving force, in accordance with instructions provided by the processor, when the counter is greater than the predetermined threshold.

Also in an exemplary embodiment, the opening member includes a rotating door; the step of automatically closing the door in accordance with the first protocol includes automatically closing the door with a first rotational drive speed, when the counter is less than the predetermined threshold; and the step of automatically closing the door in accordance with the second protocol includes automatically closing the door with a second rotational drive speed that is less than the first rotational drive speed, when the counter is greater than the predetermined threshold.

Also in an exemplary embodiment, the opening member includes a sliding door; the step of automatically closing the door in accordance with the first protocol includes automatically closing the door with a first sliding drive speed, when the counter is less than the predetermined threshold; and the step of automatically closing the door in accordance with the second protocol includes automatically closing the door with a second sliding drive speed that is less than the first sliding drive speed, when the counter is greater than the predetermined threshold.

Also in an exemplary embodiment, the opening member includes a door; the step of performing the counter includes directly calculating the amount of time after which the seal was applied to the vehicle; the step of automatically closing the door in accordance with the first protocol further includes automatically closing the door in accordance with the first protocol with the first driving force, in accordance with instructions provided by the processor, when the amount of time after which the seal was applied to the vehicle, as calculated directly by the processor performing the counter, is less than a predetermined time threshold; and the step of automatically closing the door in accordance with the second protocol further includes automatically closing the door in accordance with the second protocol with the second driving force that is less than the first driving force, in accordance with instructions provided by the processor, when the amount of time after which the seal was applied to the vehicle, as calculated directly by the processor performing the counter, is greater than the predetermined time threshold.

Also in an exemplary embodiment, the opening member includes a door; the step of performing the counter includes indirectly estimating the amount of time after which the seal was applied to the vehicle based on counting a number of actions or cycles of one or more vehicle components; the step of automatically closing the door in accordance with the first protocol further includes automatically closing the door in accordance with the first protocol with the first driving force, in accordance with instructions provided by the processor, when the counted number of actions or cycles of the one or more vehicle components is less than the predetermined threshold; and the step of automatically closing the door in accordance with the second protocol further includes automatically closing the door in accordance with the second protocol with the second driving force that is greater than the first driving force, in accordance with instructions provided by the processor, when the counted number of actions or cycles of the one or more vehicle components is greater than the predetermined threshold.

Also in an exemplary embodiment, the step of performing the counter includes indirectly estimating the amount of time after which the seal was applied to the vehicle based on counting a number of times that the door has been opened and closed; the step of automatically closing the door in accordance with the first protocol further includes automatically closing the door in accordance with the first protocol with the first driving force, in accordance with instructions provided by the processor, when the counted number of times that the door has been opened and closed is less than the predetermined threshold; and the step of automatically closing the door in accordance with the second protocol further includes automatically closing the door in accordance with the second protocol with the second driving force that is less than the first driving force, in accordance with instructions provided by the processor, when the counted number of times that the door has been opened and closed is greater than the predetermined threshold.

Also in an exemplary embodiment, the step of performing the counter includes indirectly estimating the amount of time after which the seal was applied to the vehicle based on counting a number of times that the door has been locked and unlocked; the step of automatically closing the door in accordance with the first protocol further includes automatically closing the door in accordance with the first protocol with the first driving force, in accordance with instructions provided by the processor, when the counted number of times that the door has been locked and unlocked is less than the predetermined threshold; and the step of automatically closing the door in accordance with the second protocol further includes automatically closing the door in accordance with the second protocol with the second driving force that is less than the first driving force, in accordance with instructions provided by the processor, when the counted number of times that the door has been locked and unlocked is greater than the predetermined threshold.

Also in an exemplary embodiment, the step of performing the counter includes indirectly estimating the amount of time after which the seal was applied to the vehicle based on counting a number of times that an engine of the vehicle has been turned on and off; the step of automatically closing the door in accordance with the first protocol further includes automatically closing the door in accordance with the first protocol with the first driving force, in accordance with instructions provided by the processor, when the counted number of times that the engine of the vehicle has been turned on and off is less than the predetermined threshold; and the step of automatically closing the door in accordance with the second protocol further includes automatically closing the door in accordance with the second protocol with the second driving force that is less than the first driving force, in accordance with instructions provided by the processor, when the counted number of times that the engine of the vehicle has been turned on and off is greater than the predetermined threshold.

Also in an exemplary embodiment, the opening member includes a door; the step of automatically closing the door in accordance with the first protocol includes automatically closing the door with a first drive speed that is based on a first function of drive speed versus closing distance between the door and the seal, wherein the first function includes increasing values of drive speed versus the closing distance, in accordance with instructions provided by the processor, when the counter is less than the predetermined threshold; and the step of automatically closing the door in accordance with the second protocol includes automatically closing the door with a second drive speed that is greater than the first drive speed, and wherein the second drive speed is based on a second function of drive speed versus closing distance between the door and the seal, wherein the second function includes increasing values of drive speed versus the closing distance, and wherein the second function includes an upward vertical shift of the first function, in accordance with instructions provided by the processor, when the counter is greater than the predetermined threshold.

In another exemplary embodiment, a system is provided of controlling automatic closing of a door of a vehicle with respect to a seal applied to the vehicle, the system including an input sensor and a processor. The input sensor is configured to obtain an input for closing the door; and a processor that is coupled to the input sensor. The processor is configured to at least facilitate performing a counter pertaining to an amount of time after which the seal was applied to the vehicle; and upon receiving the input for closing the door: automatically closing the door in accordance with a first protocol with a first driving force, in accordance with instructions provided by the processor, when the counter is less than a predetermined threshold; and automatically closing the door in accordance with a second protocol with a second driving force that is less than the first driving force, in accordance with instructions provided by the processor, when the counter is greater than a predetermined threshold.

Also in an exemplary embodiment, the door includes a rotating door, and the processor is further configured to at least facilitate automatically closing the door with a first rotational drive speed, when the counter is less than the predetermined threshold; and automatically closing the door with a second rotational drive speed that is greater than the first rotational drive speed, when the counter is greater than the predetermined threshold.

Also in an exemplary embodiment, the door includes a sliding door, and the processor is further configured to at least facilitate automatically closing the door with a first sliding drive speed, when the counter is less than the predetermined threshold; and automatically closing the door with a second sliding drive speed that is less than the first sliding drive speed, when the counter is greater than the predetermined threshold.

Also in an exemplary embodiment, the processor is further configured to at least facilitate performing the counter by directly calculating the amount of time after which the seal was applied to the vehicle; automatically closing the door in accordance with the first protocol with the first driving force, in accordance with instructions provided by the processor, when the amount of time after which the seal was applied to the vehicle, as calculated directly by the processor performing the counter, is less than a predetermined time threshold; and automatically closing the door in accordance with the second protocol with the second driving force that is greater than the first driving force, in accordance with instructions provided by the processor, when the amount of time after which the seal was applied to the vehicle, as calculated directly by the processor performing the counter, is greater than the predetermined time threshold.

Also in an exemplary embodiment, the processor is further configured to at least facilitate performing the counter by indirectly estimating the amount of time after which the seal was applied to the vehicle based on counting a number of actions or cycles of one or more vehicle components; automatically closing the door in accordance with the first protocol with the first driving force, in accordance with instructions provided by the processor, when the counted number of actions or cycles of the one or more vehicle components is less than the predetermined threshold; and automatically closing the door in accordance with the second protocol with the second driving force that is greater than the first driving force, in accordance with instructions provided by the processor, when the counted number of actions or cycles of the one or more vehicle components is greater than the predetermined threshold.

Also in an exemplary embodiment, the processor is further configured to at least facilitate performing the counter by indirectly estimating the amount of time after which the seal was applied to the vehicle based on counting a number of times that the door has been opened and closed; automatically closing the door in accordance with the first protocol with the first driving force, in accordance with instructions provided by the processor, when the counted number of times that the door has been opened and closed is less than the predetermined threshold; and automatically closing the door in accordance with the second protocol with the second driving force that is greater than the first driving force, in accordance with instructions provided by the processor, when the counted number of times that the door has been opened and closed is greater than the predetermined threshold.

Also in an exemplary embodiment, the processor is further configured to at least facilitate performing the counter by indirectly estimating the amount of time after which the seal was applied to the vehicle based on counting a number of times that the door has been locked and unlocked; automatically closing the door in accordance with the first protocol with the first driving force, in accordance with instructions provided by the processor, when the counted number of times that the door has been locked and unlocked is less than the predetermined threshold; and automatically closing the door in accordance with the second protocol with the second driving force that is greater than the first driving force, in accordance with instructions provided by the processor, when the counted number of times that the door has been locked and unlocked is greater than the predetermined threshold.

Also in an exemplary embodiment, the processor is further configured to at least facilitate performing the counter by indirectly estimating the amount of time after which the seal was applied to the vehicle based on counting a number of times that an engine of the vehicle has been turned on and off; automatically closing the door in accordance with the first protocol with the first driving force, in accordance with instructions provided by the processor, when the counted number of times that the engine of the vehicle has been turned on and off is less than the predetermined threshold; and automatically closing the door in accordance with the second protocol with the second driving force that is greater than the first driving force, in accordance with instructions provided by the processor, when the counted number of times that the engine of the vehicle has been turned on and off is greater than the predetermined threshold.

Also in an exemplary embodiment, the processor is further configured to at least facilitate, upon receiving the input for closing the door: automatically closing the door with a first drive speed that is based on a first function of drive speed versus closing distance between the door and the seal, wherein the first function includes increasing values of drive speed versus the closing distance, in accordance with instructions provided by the processor, when the counter is less than the predetermined threshold; and automatically closing the door with a second drive speed that is greater than the first drive speed, and wherein the second drive speed is based on a second function of drive speed versus closing distance between the door and the seal, wherein the second function includes increasing values of drive speed versus the closing distance, and wherein the second function includes an upward vertical shift of the first function, in accordance with instructions provided by the processor, when the counter is greater than the predetermined threshold.

In another exemplary embodiment, a vehicle is provided that includes a body, a seal applied to the body, a door that is configured to be opened and closed, and that is configured to contact the seal when the door is closed; an actuator configured to move the door; an input sensor configured to obtain an input for closing the door; and a processor that is coupled to the input sensor and to the actuator, the processor configured to at least facilitate performing a counter pertaining to an amount of time after which the seal was applied to the vehicle; and upon receiving the input for closing the door: automatically closing the door in accordance with a first protocol with a first driving force and with a first drive speed, in accordance with instructions provided by the processor to the actuator and that are implemented by the actuator in automatically closing the door, when the counter is less than a predetermined threshold; and automatically closing the door in accordance with a second protocol with a second driving force that is greater than the first driving force, and with a second drive speed that is greater than the first drive speed, in accordance with instructions provided by the processor to the actuator and that are implemented by the actuator in automatically closing the door, when the counter is greater than a predetermined threshold.

Also in an exemplary embodiment, the processor is further configured to at least facilitate, upon receiving the input for closing the door: automatically closing the door with the first drive speed, wherein the first drive speed is based on a first function of drive speed versus closing distance between the door and the seal, and wherein the first function includes increasing values of drive speed versus the closing distance, in accordance with instructions provided by the processor, when the counter is less than the predetermined threshold; and automatically closing the door with the second drive speed, wherein the second drive speed is greater than the first drive speed, and wherein the second drive speed is based on a second function of drive speed versus closing distance between the door and the seal, wherein the second function includes increasing values of drive speed versus the closing distance, and wherein the second function includes an upward vertical shift of the first function, in accordance with instructions provided by the processor, when the counter is greater than the predetermined threshold.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a plurality of doors (or other opening members) in addition to a control system for automatically controlling the doors, with different closing profiles based on an age of a seal of the doors, in accordance with exemplary embodiments;

FIGS. 2-4 provide exemplary illustrations of a door and a seal for the door as installed in a vehicle, and that can be utilized in connection with the vehicle of FIG. 1, in accordance with exemplary embodiments;

FIG. 5 provides a flowchart of a process for automatically controlling power doors of a vehicle utilizing different closing profiles for the power doors based on an age of a seal of the power doors, and that can be implemented in connection with the vehicle of FIG. 1 and the doors of FIGS. 1-4 in accordance with exemplary embodiments; and

FIG. 6 provides a graphical illustration of an implementation of the process of FIG. 5 with respect to an implementation of profile changes for closing a door of a vehicle based on the age of the seal, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

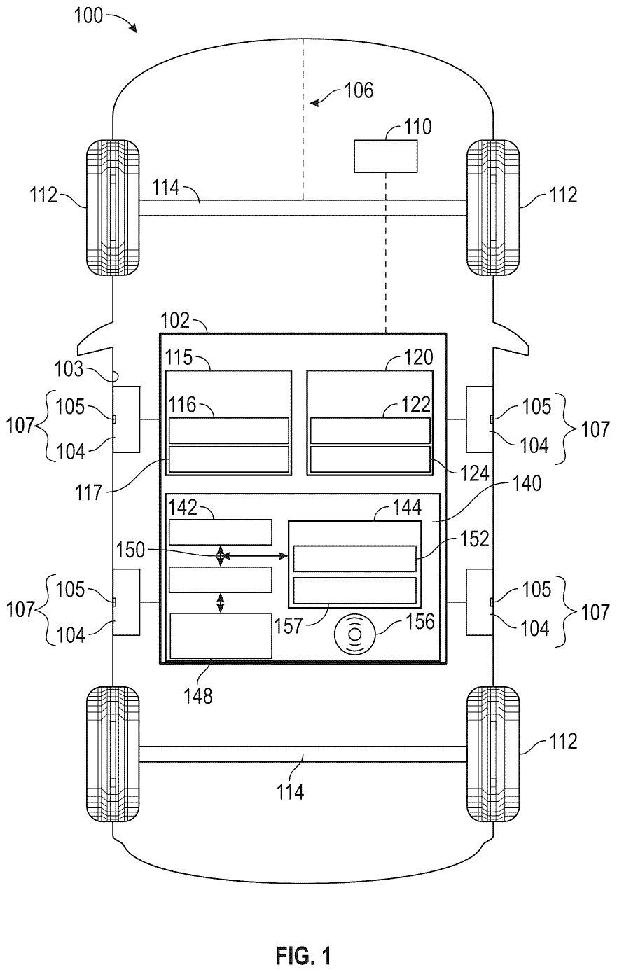

FIG. 1 illustrates a vehicle 100, according to an exemplary embodiment. As described in greater detail further below, the vehicle 100 includes a plurality of doors 104 and respective seals 105 for the doors 104, along with a control system 102 configured for automatically controlling the doors 104, including using different protocols for closing the doors 104 based on age of the seals 105 (as described in greater detail further below). As used throughout this Application, the term “doors” may also refer to other opening members of the vehicle 100, such as trunks, hatches, and the like.

As depicted in FIG. 1, in various embodiments the vehicle 100 includes an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise a motorcycle or other vehicle, such as aircraft, spacecraft, watercraft, and so on, and/or one or more other types of mobile platforms (e.g., a robot and/or other mobile platform).

The vehicle 100 includes a body 103 that is arranged on a chassis 106. The body 103 substantially encloses other components of the vehicle 100. The body 103 and the chassis 106 may jointly form a frame. The vehicle 100 also includes a plurality of wheels 112. The wheels 112 are each rotationally coupled to the chassis 106 near a respective corner of the body 103 to facilitate movement of the vehicle 100. In one embodiment, the vehicle 100 includes four wheels 112, although this may vary in other embodiments (for example for trucks and certain other vehicles).

A drive system 110 is mounted on the chassis 106, and drives the wheels 112, for example via axles 114. In certain embodiments, the drive system 110 comprises a propulsion system. In certain exemplary embodiments, the drive system 110 comprises an internal combustion engine and/or an electric motor/generator, coupled with a transmission thereof. In certain embodiments, the drive system 110 may vary, and/or two or more drive systems 110 may be used.

In various embodiments, the doors 104 comprise power doors that are automatically controlled by the control system 102. In the depicted embodiment the vehicle 100 has four doors 104, for example including two front doors 104 (e.g., by a front row of seats of the vehicle 100) and two rear doors 104 (e.g., by one or more rear rows of seats of the vehicle 100). In certain embodiments, the number of doors 104 of the vehicle 100 may vary.

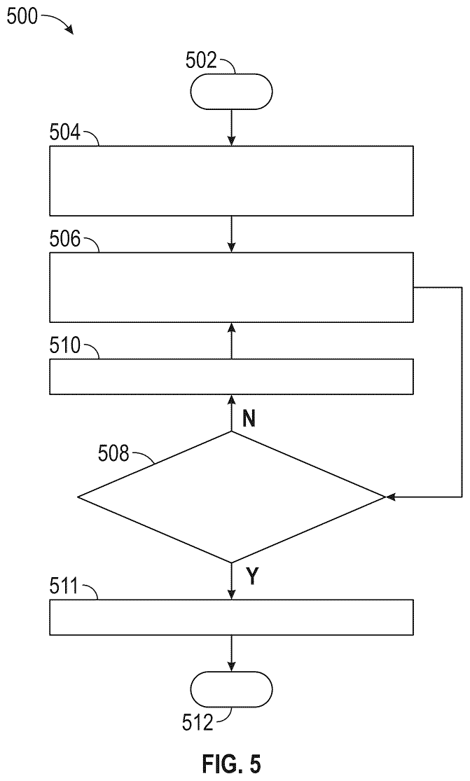

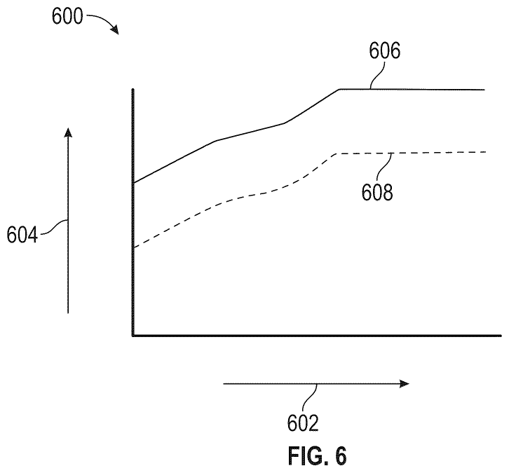

As depicted in FIG. 1, in various embodiments the vehicle 100 includes seals 105 in or on the body 103 for each of the respective doors 104, such that a particular door 104 contacts a respective one of the seals 105 when the particular door closes. In various embodiments, the seals 105 are put onto the vehicle 100 during manufacturing of the vehicle 100. In certain embodiments, each seal 105 begins as a new seal 105 (also referred to herein as a temporary seal or a green seal) when the seal 105 is first applied to the vehicle 100, and subsequently becomes an aged seal 105 (also referred to as an aged seal or a permanent seal). In various embodiments, the compression force for closing the door 104 changes as the seal 105 transforms from a new seal to an aged seal, and this information is utilized for the protocols for automated control of closing the door 104, as described further below in connection with the control system 102 of FIG. 1, the process 500 of FIG. 5, and the implementation of FIG. 6.

In certain embodiments, the doors 104 comprise sliding doors, wherein the doors 104 are opened and closed by sliding movement. In other embodiments, the doors 104 comprise swinging doors, wherein the doors 104 are opened and closed by swinging movement. In certain embodiments, some of the doors 104 (e.g., front doors) may comprise sliding doors, whereas other of the doors 104 (e.g., rear doors) may comprise sliding doors.

As depicted in FIG. 1, in certain embodiments, the doors 104 and the respective seals 105 may collectively considered to form a door system 107.

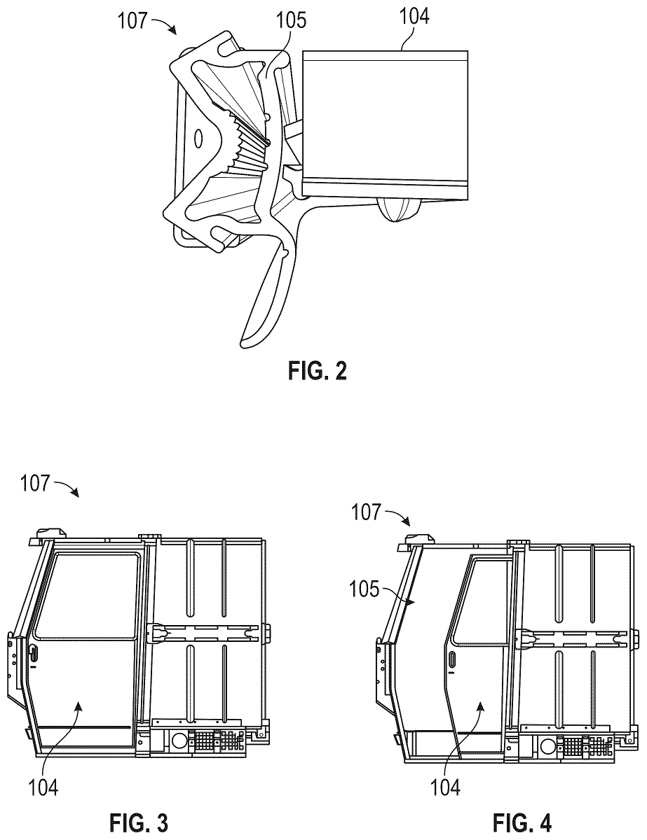

With reference to FIGS. 2-4, illustrations are provided of exemplary implementations of the door system 107 of FIG. 1, in accordance with exemplary embodiments.

With reference to FIG. 2, an illustration is provided of the door 104 alongside the seal 105 as part of the door system 107. In various embodiments, as referenced above, the door 104 contacts the seal 105 when the door 104 closes.

With further reference to FIG. 3, an illustration is provided of the door system 107 in a situation in which the door 104 is closed. In various embodiments, when the door 104 is closed (as depicted in FIG. 3), the door 104 contacts the seal 105, and the seal 105 is not visible.

With further reference to FIG. 4, an illustration is provided of the door system 107 in a situation in which the door 104 is open. In various embodiments, when the door 104 is opened (as depicted in FIG. 4), the door 104 does not contact the seal 105, and the seal 105 is visible.

With reference back to FIG. 1, in various embodiments the doors 104 comprise power doors (as noted above) that are automatically controlled by the control system, using different profiles that vary based on the age of the seal 105 (as discussed in greater detail further below).

With continued reference to FIG. 1, in various embodiments the control system 102 is coupled to the doors 104, and controls operation thereof, including in accordance with the process 500 of FIG. 5 and the implementations of FIG. 6. In certain embodiments, the control system 102 may also be coupled to one or more other vehicle systems (e.g., the drive system 110, among others) and control operation thereof in whole or in part. Also in certain embodiments, the control system 102 is part of or coupled to a body control module (BCM) for the vehicle 100; however, this may vary in other embodiments.

As depicted in FIG. 1, in various embodiments, the control system 102 includes a door control module 115 along with a sensor array 120 and a controller 140, as described in greater detail below.

In various embodiments, the door control module 115 includes one or more actuators 116 and a processor 117. In certain embodiments the door control module 115 may be considered to be part of the control system 102, whereas in other embodiments the door control module 115 may considered to be separate from and/or coupled to the control system 102. In various embodiments, the actuators 116 automatically move the doors 104 (including opening and closing the doors 104) in accordance with instructions provided thereto by the processor 117 and/or via the controller 140. In certain embodiments, the controller 140 provides instructions to the processor 117 of the door control module 115 that are then implemented by the actuators 116 for moving the doors 104; however, this may vary in other embodiments.

In various embodiments, the sensor array 120 includes various sensors that obtain sensor data for use in controlling the automatic operation of the doors 104. In various embodiments, the sensor array 120 includes one or more input sensors 122. Also in certain embodiments, the sensor array 120 may also include one or more other sensors 124.

In various embodiments, the input sensors 122 detect an input from one or more drivers or other users of the vehicle 100, including for opening and closing of the doors 104 of the vehicle 100. In certain embodiments, the input sensors 122 are part of or coupled to one or more buttons for controlling opening and closing of the doors 104. For example, in various embodiments, these inputs may be provided via buttons or other input devices on the doors 104, or on the body 103 of the vehicle 100, or on a touch screen or control panel of the vehicle 100, or a key fob of the user, and/or one or more other input devices or techniques.

Also in various embodiments, the other sensors 124 may comprise one or more other sensors pertaining to the doors 104 and/or other components of the vehicle 100, and/or for sensor information used for determining an age of the seal 105 (e.g., sensor data pertaining to a number of times that the doors 104 have been opened and closed or locked and unlocked, a number of times that the drive system 110 has been turned on, a number of vehicle 100 drives or ignition cycles, and so on. Also in certain embodiments, the other sensors 124 may also detect a current position of the doors 104 (e.g., open or closed), along with a current closing distance of the doors 104 (i.e., a distance of each door 104 to its respective seal 105) and other parameters relating to the doors 104 and/or the operation and/or status thereof.

In various embodiments, the controller 140 is coupled to the door control module 115, and to the sensor array 120. In certain embodiments, the controller 140 may also be coupled to one or more other vehicle systems, such as the drive system 110. Also in various embodiments, the controller 140 comprises a computer system (also referred to herein as computer system 140), and includes a processor 142, a memory 144, an interface 146, a storage device 148, and a computer bus 150. In various embodiments, the controller (or computer system) 140 controls the display 130, including the information with respect to the doors 104 that is provided on the display 130 for the driver or other user of the vehicle 100. In various embodiments, the controller 140 provides these and other functions in accordance with the steps of the process 500 of FIG. 5 and the implementations of FIG. 6.

In various embodiments, the controller 140 (and, in certain embodiments, the control system 102 itself) is disposed within the body 103 of the vehicle 100. In one embodiment, the control system 102 is mounted on the chassis 106. In certain embodiments, the controller 140 and/or control system 102 and/or one or more components thereof may be disposed outside the body 103, for example on a remote server, in the cloud, or other device where image processing is performed remotely.

It will be appreciated that the controller 140 may otherwise differ from the embodiment depicted in FIG. 1. For example, the controller 140 may be coupled to or may otherwise utilize one or more remote computer systems and/or other control systems, for example as part of one or more of the above-identified vehicle 100 devices and systems.

In the depicted embodiment, the computer system of the controller 140 includes a processor 142, a memory 144, an interface 146, a storage device 148, and a bus 150. The processor 142 performs the computation and control functions of the controller 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the controller 140 and the computer system of the controller 140, generally in executing the processes described herein, such as the process 500 of FIG. 5 and the implementations of FIG. 6.

The memory 144 can be any type of suitable memory. For example, the memory 144 may include various types of dynamic random access memory (DRAM) such as SDRAM, the various types of static RAM (SRAM), and the various types of non-volatile memory (PROM, EPROM, and flash). In certain examples, the memory 144 is located on and/or co-located on the same computer chip as the processor 142. In the depicted embodiment, the memory 144 stores the above-referenced program 152 along with stored values 157 (e.g., threshold values for the process 500 in various embodiments).

The bus 150 serves to transmit programs, data, status and other information or signals between the various components of the computer system of the controller 140. The interface 146 allows communication to the computer system of the controller 140, for example from a system driver and/or another computer system, and can be implemented using any suitable method and apparatus. In one embodiment, the interface 146 obtains the various data from the sensor array 120, among other possible data sources. The interface 146 can include one or more network interfaces to communicate with other systems or components. The interface 146 may also include one or more network interfaces to communicate with technicians, and/or one or more storage interfaces to connect to storage apparatuses, such as the storage device 148.

The storage device 148 can be any suitable type of storage apparatus, including various different types of direct access storage and/or other memory devices. In one exemplary embodiment, the storage device 148 comprises a program product from which memory 144 can receive a program 152 that executes one or more embodiments of one or more processes of the present disclosure, such as the steps of the process 500 discussed further below in connection with FIG. 5 and the implementations of FIG. 6. In another exemplary embodiment, the program product may be directly stored in and/or otherwise accessed by the memory 144 and/or a disk (e.g., disk 156), such as that referenced below.

The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 140 may also otherwise differ from the embodiment depicted in FIG. 1, for example in that the computer system of the controller 140 may be coupled to or may otherwise utilize one or more remote computer systems and/or other control systems.

FIG. 5 is a flowchart of a process 500 for automatically controlling power doors of a vehicle utilizing different closing profiles for the power doors based on an age of a seal of the power doors, in accordance with exemplary embodiments. Also in various embodiments, the process 500 can be implemented in connection with the vehicle 100 of FIG. 1, including the control system 102 of FIG. 1 and the doors 104 and the door system 107 of FIGS. 1-4. The process 500 is described below in connection with the flowchart as presented in FIG. 5 as well as the implementations that are depicted in FIG. 6 and that are described in greater detail further below in connection therewith.

As depicted in FIG. 5, in various embodiments, the process 500 begins at step 502. In one embodiment, the process 500 begins when the vehicle 100 is being manufactured and continues after the vehicle 100 is manufactured.

In various embodiments, during step 504, power door controls for the doors 104 of the vehicle 100 are learned at a manufacturing plant or facility as the vehicle 100 is manufactured. Specifically, in various embodiments, the processor 142 determines a first protocol for automatically controlling the doors 104, including closing of the doors 104 against respective seals 105 of the vehicle 100 after the seals 105 are first applied to the body 103 of the vehicle 100. In certain embodiments, the first protocol is determined by the vehicle 100 based on information (or in certain embodiments the protocol itself) stored in the memory 144 as stored values 157 therein.

Specifically, in various embodiments during step 504, when the door 104 is closed (e.g., as implemented when a request to close the door 104 is received via one or more input sensors 122), the doors 104 are automatically closed in accordance with the first protocol. In various embodiments, during these circumstances, the actuators 116 close the doors 104 with the amount of driving force (and resulting drive speed) corresponding to the first profile, in accordance with instructions provided by one or both of the processors 142, 117. As noted above, in certain embodiments, the processor 142 (e.g., of a BCM of a vehicle) provides instructions to the processor 117 (e.g., of the door control module 115) for movement of the actuators 116 to close the doors 104 in accordance with the first profile.

In various embodiments, the first protocol includes an amount of driving force (and a corresponding drive speed) of the actuators 116 of FIG. 1 for closing each of the respective doors 104 against their respective seals 105 when the doors 104 are closed. In various embodiments, the driving force and drive speed depend on a closing distance of the doors 104 from the seals 105 (e.g., as detected via one or more other sensors 124 of FIG. 1 in certain embodiments), with the driving force and drive speed generally being greater when the closing distance is greater, and with the driving force and drive speed generally decreasing as the closing distance decreases (i.e., as the door 104 approaches the seal 105).

In addition, when the seal 105 is relatively new (e.g., as the vehicle 100 is still being manufactured, or in certain embodiments shortly thereafter), the driving force (and corresponding drive speed) are relatively greater for a predetermined of time (i.e., as the seal 105 ages and before the seal 105 becomes aged or permanent) to accommodate the greater compression force of the seal 105 during this initial time period. In various embodiments, during this preliminary time (i.e., as the seal 105 is still new) the driving force (and corresponding drive speed) is less than it will subsequently be in a new profile after the seal 105 becomes aged or permanent (discussed further below).

As noted above, in certain embodiments the doors 104 may comprise rotating doors, whereas in certain other embodiments the doors 104 may comprise sliding doors. In certain embodiments in one or more doors 104 are rotating doors, the driving force is applied to the doors 104 by the actuators 116 to rotate the doors 104 with a rotational drive speed that is relatively greater while the seal 105 is new in step 504 (as compared to when the seal 105 is aged, as described further below).

In various embodiments, a counter is initiated (step 506). In various embodiments, the counter may comprise any number of techniques utilize for determining or approximating an amount of time after which the seal 105 has been applied to the vehicle 100, or, alternatively stated, whether the seal 105 is still new or whether the seal 105 has become aged (e.g., permanent). In various embodiments, the counter is initiated, incremented, and monitored by the processor 142 using any number of counting or related techniques, such as those described below, among others.

For example, in certain embodiments, the counter may be based on one or more vehicle 100 apparatus or systems, such as number of times that the doors 104 have been opened and closed or locked and unlocked, a number of vehicle starts (e.g., for the engine and/or drive system 110, such as a number of times that an engine of the drive system 110 has been turned on and off), a number of vehicle drives, a number of hall counts, a number of latch cycles, a number of door cycles, and/or any number of other such techniques. In addition, in certain embodiments, the processor 142 may also keep track of the amount of time directly (e.g., via a vehicle clock or timer), and/or may keep track of the amount of time based on readings of dates and times either kept internal to the vehicle 100 and/or as obtained from one or more other outside sources (e.g., a universal date and time source).

Also in various embodiments, the processor 142 uses one or more such techniques (or similar techniques) in determining whether the counter has exceeded a predetermined threshold (step 508). In various embodiments, the predetermined threshold corresponds to an amount of time (or a proxy or other parameter indicative of an estimated amount of time) that the seal 105 has aged (i.e., an amount of time after the seal 105 was applied to the vehicle 100 during manufacturing of the vehicle 100). In certain embodiments, the predetermined threshold of step 508 is a calibratable value that is stored in the memory 144 as a stored value 157 therein.

In various embodiments, if it is determined in step 508 that the counter has not reached the predetermined threshold, then the process proceeds to step 510. In various embodiments, during step 510, the first door control protocol of step 504 is maintained. Specifically, in various embodiments, during step 510 when the door 104 is closed (e.g., as implemented when a request to close the door 104 is received via one or more input sensors 122), the doors 104 are automatically closed in accordance with the first protocol of step 504. In various embodiments, during these circumstances, the actuators 116 close the doors 104 with the amount of driving force (and resulting drive speed) corresponding to the first profile, in accordance with instructions provided by one or both of the processors 142, 117. As noted above, in certain embodiments, the processor 142 (e.g., of a BCM of a vehicle) provides instructions to the processor 117 (e.g., of the door control module 115) for movement of the actuators 116 to close the doors 104 in accordance with the first profile.

In various embodiments, the process 500 then proceeds to step 506, as the counter is incremented and the process 500 continues with an updated performance of step 506 in a new iteration.

Conversely, in various embodiments, if it is instead determined in step 508 that the counter has reached the predetermined threshold, then the process proceeds instead to step 511. In various embodiments, during step 511, a second door control protocol is initiated. In various embodiments, the second door control protocol of step 511 provides decreased driving force (resulting in decreased drive speed) for closing the doors 104 as compared with the first protocol of step 504. In certain embodiments, the second protocol provides a relative decrease in the driving force (resulting in decreased drive speed) at each closing distance as compared with the first protocol of step 504 (as described in greater detail further below in connection with FIG. 6 in accordance with an exemplary implementation).

With continued reference to FIG. 5, in an exemplary embodiment, during step 511 when the door 104 is closed (e.g., as implemented when a request to close the door 104 is received via one or more input sensors 122), the doors 104 are automatically closed in accordance with the second protocol of step 511. In various embodiments, during these circumstances, the actuators 116 close the doors 104 with the amount of driving force (and resulting drive speed) corresponding to the second profile, in accordance with instructions provided by one or both of the processors 142, 117. Similar to the discussion above, as noted above, in certain embodiments, the processor 142 (e.g., of a BCM of a vehicle) provides instructions to the processor 117 (e.g., of the door control module 115) for movement of the actuators 116 to close the doors 104 in accordance with the second profile.

As noted above, in certain embodiments the doors 104 may comprise rotating doors, whereas in certain other embodiments the doors 104 may comprise sliding doors. In certain embodiments in one or more doors 104 are rotating doors, the driving force is applied to the doors 104 by the actuators 116 to rotate the doors 104 with a rotational drive speed that is relatively less while the seal 105 is aged in step 511 (as compared to when the seal 105 is new, as described above with respect to step 504).

In various embodiments, the process 500 then terminates at 512.

With reference to FIG. 6, a graphical illustration 600 is provided with respect to the process 500 of FIG. 5, in accordance with an exemplary embodiment. As depicted in FIG. 6, in an exemplary embodiment the graphical illustration 600 includes an x-axis 602 representing closing distance (i.e., between the door 104 and the seal 105 as the door 104 closes), whereas the y-axis 604 represents drive speed of the door 104 as its is moved as it is being closed by the actuator 116.

With continued reference to FIG. 6, a first function 606 that corresponds to the first protocol of step 504 (i.e., when the seal 105 is still new). As illustrated in FIG. 6, with the first function 606 the drive speed generally increases with the closing distance. Further, in the illustrated embodiment of FIG. 1 with the first function 606, the rate of increase of the drive speed with respect to the closing distance is relatively greater at lower closing distances (i.e., with a relatively larger slope) and is relatively smaller at higher closing distances (i.e., with a relatively smaller slope as the curve levels out as shown in FIG. 6).

Also as depicted in FIG. 6, a second function 608 corresponds to the second protocol of step 511 (i.e., after the seal 105 has aged). As illustrated in FIG. 6, for the second function 608, the drive speed also generally increases with the closing distance, and the rate of increase of the drive speed with respect to the closing distance is relatively greater at lower closing distances (i.e., with a relatively larger slope) and is relatively smaller at higher closing distances (i.e., with a relatively smaller slope as the curve levels out as shown in FIG. 6).

However, as depicted in FIG. 6, the second function 608 includes a drive speed that is greater than a respective drive speed for the first function 606 at each particular closing distance level. Accordingly, as depicted in FIG. 6, in an exemplary embodiment the second function 608 corresponds to an upward vertical shift of the first function 606. In accordance with exemplary embodiments, this demonstrates how the drive speed decreases from the second protocol of step 511 as compared to the first protocol of step 504, and particularly how the drive speed decreases for the second protocol of step 511 as compared with the first protocol of step 511 as compared with the first protocol of step 504 for each particular closing distance value. In certain embodiments, during the second protocol of step 511 less kinetic energy is required to close the door because the aged seal does not require as much closing force (as opposed to steps 504 and 606 that require relatively higher speed and kinetic energy to do newer “green” sales having a higher force).

Accordingly, methods, systems, and vehicles are provided for automatically controlling power doors of a vehicle utilizing different closing profiles for the power doors based on an age of a seal of the power doors. As described above, in exemplary embodiments, different protocols are utilized for closing the power doors with different driving forces (and different corresponding drive speeds) based on the age of the seal. Specifically, in various embodiments, a counter is utilized for determining or estimating an amount of time after which the seal was applied, and a different driving force is applied (with different drive speed) based on whether the counter has exceeded a predetermined threshold (i.e., based on whether the seal is determined to be new or aged).

It will be appreciated that the systems, vehicles, and methods may vary from those depicted in the Figures and described herein. For example, the vehicle 100 of FIG. 1, including the doors 104 and the control system 102 and components thereof, may vary in different embodiments. It will similarly be appreciated that the steps of the process 500 may differ from that depicted in FIG. 5, and/or that various steps of the process 500 may occur concurrently and/or in a different order than that depicted in FIG. 5. It will similarly be appreciated that the implementations of FIGS. 2-4 and 6 may also differ in various embodiments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of controlling automatic closing of an opening member of a vehicle with respect to a seal applied to the vehicle, the method comprising:
performing a counter, via a processor, pertaining to an amount of time after which the seal was applied to the vehicle;
automatically closing the door in accordance with a first protocol with a first driving force, in accordance with instructions provided by the processor, when the counter is less than a predetermined threshold; and
automatically closing the door in accordance with a second protocol with a second driving force that is less than the first driving force, in accordance with instructions provided by the processor, when the counter is greater than the predetermined threshold.

2. The method of claim 1, wherein:
the opening member comprises a rotating door;
the step of automatically closing the door in accordance with the first protocol comprises automatically closing the door with a first rotational drive speed, when the counter is less than the predetermined threshold; and
the step of automatically closing the door in accordance with the second protocol comprises automatically closing the door with a second rotational drive speed that is less than the first rotational drive speed, when the counter is greater than the predetermined threshold.

3. The method of claim 1, wherein:
the opening member comprises a sliding door;
the step of automatically closing the door in accordance with the first protocol comprises automatically closing the door with a first sliding drive speed, when the counter is less than the predetermined threshold; and
the step of automatically closing the door in accordance with the second protocol comprises automatically closing the door with a second sliding drive speed that is less than the first sliding drive speed, when the counter is greater than the predetermined threshold.

4. The method of claim 1, wherein:
the opening member comprises a door;
the step of performing the counter comprises directly calculating the amount of time after which the seal was applied to the vehicle;
the step of automatically closing the door in accordance with the first protocol further comprises automatically closing the door in accordance with the first protocol with the first driving force, in accordance with instructions provided by the processor, when the amount of time after which the seal was applied to the vehicle, as calculated directly by the processor performing the counter, is less than a predetermined time threshold; and
the step of automatically closing the door in accordance with the second protocol further comprises automatically closing the door in accordance with the second protocol with the second driving force that is less than the first driving force, in accordance with instructions provided by the processor, when the amount of time after which the seal was applied to the vehicle, as calculated directly by the processor performing the counter, is greater than the predetermined time threshold.

5. The method of claim 1, wherein:
the opening member comprises a door;
the step of performing the counter comprises indirectly estimating the amount of time after which the seal was applied to the vehicle based on counting a number of actions or cycles of one or more vehicle components;
the step of automatically closing the door in accordance with the first protocol further comprises automatically closing the door in accordance with the first protocol with the first driving force, in accordance with instructions provided by the processor, when the counted number of actions or cycles of the one or more vehicle components is less than the predetermined threshold; and
the step of automatically closing the door in accordance with the second protocol further comprises automatically closing the door in accordance with the second protocol with the second driving force that is greater than the first driving force, in accordance with instructions provided by the processor, when the counted number of actions or cycles of the one or more vehicle components is greater than the predetermined threshold.

6. The method of claim 5, wherein:
the step of performing the counter comprises indirectly estimating the amount of time after which the seal was applied to the vehicle based on counting a number of times that the door has been opened and closed;
the step of automatically closing the door in accordance with the first protocol further comprises automatically closing the door in accordance with the first protocol with the first driving force, in accordance with instructions provided by the processor, when the counted number of times that the door has been opened and closed is less than the predetermined threshold; and
the step of automatically closing the door in accordance with the second protocol further comprises automatically closing the door in accordance with the second protocol with the second driving force that is less than the first driving force, in accordance with instructions provided by the processor, when the counted number of times that the door has been opened and closed is greater than the predetermined threshold.

7. The method of claim 5, wherein:
the step of performing the counter comprises indirectly estimating the amount of time after which the seal was applied to the vehicle based on counting a number of times that the door has been locked and unlocked;
the step of automatically closing the door in accordance with the first protocol further comprises automatically closing the door in accordance with the first protocol with the first driving force, in accordance with instructions provided by the processor, when the counted number of times that the door has been locked and unlocked is less than the predetermined threshold; and
the step of automatically closing the door in accordance with the second protocol further comprises automatically closing the door in accordance with the second protocol with the second driving force that is less than the first driving force, in accordance with instructions provided by the processor, when the counted number of times that the door has been locked and unlocked is greater than the predetermined threshold.

8. The method of claim 5, wherein:
the step of performing the counter comprises indirectly estimating the amount of time after which the seal was applied to the vehicle based on counting a number of times that an engine of the vehicle has been turned on and off;
the step of automatically closing the door in accordance with the first protocol further comprises automatically closing the door in accordance with the first protocol with the first driving force, in accordance with instructions provided by the processor, when the counted number of times that the engine of the vehicle has been turned on and off is less than the predetermined threshold; and
the step of automatically closing the door in accordance with the second protocol further comprises automatically closing the door in accordance with the second protocol with the second driving force that is less than the first driving force, in accordance with instructions provided by the processor, when the counted number of times that the engine of the vehicle has been turned on and off is greater than the predetermined threshold.

9. The method of claim 1, wherein:
the opening member comprises a door;
the step of automatically closing the door in accordance with the first protocol comprises automatically closing the door with a first drive speed that is based on a first function of drive speed versus closing distance between the door and the seal, wherein the first function includes increasing values of drive speed versus the closing distance, in accordance with instructions provided by the processor, when the counter is less than the predetermined threshold; and
the step of automatically closing the door in accordance with the second protocol comprises automatically closing the door with a second drive speed that is greater than the first drive speed, and wherein the second drive speed is based on a second function of drive speed versus closing distance between the door and the seal, wherein the second function includes increasing values of drive speed versus the closing distance, and wherein the second function comprises an upward vertical shift of the first function, in accordance with instructions provided by the processor, when the counter is greater than the predetermined threshold.

10. A system of controlling automatic closing of a door of a vehicle with respect to a seal applied to the vehicle, the system comprising:
an input sensor configured to obtain an input for closing the door; and
a processor that is coupled to the input sensor, the processor configured to at least facilitate:
performing a counter pertaining to an amount of time after which the seal was applied to the vehicle; and
upon receiving the input for closing the door:
automatically closing the door in accordance with a first protocol with a first driving force, in accordance with instructions provided by the processor, when the counter is less than a predetermined threshold; and
automatically closing the door in accordance with a second protocol with a second driving force that is less than the first driving force, in accordance with instructions provided by the processor, when the counter is greater than a predetermined threshold.

11. The system of claim 10, wherein the door comprises a rotating door, and the processor is further configured to at least facilitate:
automatically closing the door with a first rotational drive speed, when the counter is less than the predetermined threshold; and
automatically closing the door with a second rotational drive speed that is greater than the first rotational drive speed, when the counter is greater than the predetermined threshold.

12. The system of claim 10, wherein the door comprises a sliding door, and the processor is further configured to at least facilitate:
automatically closing the door with a first sliding drive speed, when the counter is less than the predetermined threshold; and
automatically closing the door with a second sliding drive speed that is less than the first sliding drive speed, when the counter is greater than the predetermined threshold.

13. The system of claim 10, wherein the processor is further configured to at least facilitate:
performing the counter by directly calculating the amount of time after which the seal was applied to the vehicle;
automatically closing the door in accordance with the first protocol with the first driving force, in accordance with instructions provided by the processor, when the amount of time after which the seal was applied to the vehicle, as calculated directly by the processor performing the counter, is less than a predetermined time threshold; and
automatically closing the door in accordance with the second protocol with the second driving force that is greater than the first driving force, in accordance with instructions provided by the processor, when the amount of time after which the seal was applied to the vehicle, as calculated directly by the processor performing the counter, is greater than the predetermined time threshold.

14. The system of claim 10, wherein the processor is further configured to at least facilitate:
performing the counter by indirectly estimating the amount of time after which the seal was applied to the vehicle based on counting a number of actions or cycles of one or more vehicle components;
automatically closing the door in accordance with the first protocol with the first driving force, in accordance with instructions provided by the processor, when the counted number of actions or cycles of the one or more vehicle components is less than the predetermined threshold; and
automatically closing the door in accordance with the second protocol with the second driving force that is greater than the first driving force, in accordance with instructions provided by the processor, when the counted number of actions or cycles of the one or more vehicle components is greater than the predetermined threshold.

15. The system of claim 14, wherein the processor is further configured to at least facilitate:
performing the counter by indirectly estimating the amount of time after which the seal was applied to the vehicle based on counting a number of times that the door has been opened and closed;
automatically closing the door in accordance with the first protocol with the first driving force, in accordance with instructions provided by the processor, when the counted number of times that the door has been opened and closed is less than the predetermined threshold; and
automatically closing the door in accordance with the second protocol with the second driving force that is greater than the first driving force, in accordance with instructions provided by the processor, when the counted number of times that the door has been opened and closed is greater than the predetermined threshold.

16. The system of claim 14, wherein the processor is further configured to at least facilitate:
performing the counter by indirectly estimating the amount of time after which the seal was applied to the vehicle based on counting a number of times that the door has been locked and unlocked;
automatically closing the door in accordance with the first protocol with the first driving force, in accordance with instructions provided by the processor, when the counted number of times that the door has been locked and unlocked is less than the predetermined threshold; and
automatically closing the door in accordance with the second protocol with the second driving force that is greater than the first driving force, in accordance with instructions provided by the processor, when the counted number of times that the door has been locked and unlocked is greater than the predetermined threshold.

17. The system of claim 14, wherein the processor is further configured to at least facilitate:
performing the counter by indirectly estimating the amount of time after which the seal was applied to the vehicle based on counting a number of times that an engine of the vehicle has been turned on and off;
automatically closing the door in accordance with the first protocol with the first driving force, in accordance with instructions provided by the processor, when the counted number of times that the engine of the vehicle has been turned on and off is less than the predetermined threshold; and
automatically closing the door in accordance with the second protocol with the second driving force that is greater than the first driving force, in accordance with instructions provided by the processor, when the counted number of times that the engine of the vehicle has been turned on and off is greater than the predetermined threshold.

18. The system of claim 10, wherein the processor is further configured to at least facilitate, upon receiving the input for closing the door:
automatically closing the door with a first drive speed that is based on a first function of drive speed versus closing distance between the door and the seal, wherein the first function includes increasing values of drive speed versus the closing distance, in accordance with instructions provided by the processor, when the counter is less than the predetermined threshold; and
automatically closing the door with a second drive speed that is greater than the first drive speed, and wherein the second drive speed is based on a second function of drive speed versus closing distance between the door and the seal, wherein the second function includes increasing values of drive speed versus the closing distance, and wherein the second function comprises an upward vertical shift of the first function, in accordance with instructions provided by the processor, when the counter is greater than the predetermined threshold.

19. A vehicle comprising:
a body
a seal applied to the body;
a door that is configured to be opened and closed, and that is configured to contact the seal when the door is closed;
an actuator configured to move the door;
an input sensor configured to obtain an input for closing the door; and
a processor that is coupled to the input sensor and to the actuator, the processor configured to at least facilitate:
performing a counter pertaining to an amount of time after which the seal was applied to the vehicle; and
upon receiving the input for closing the door:
automatically closing the door in accordance with a first protocol with a first driving force and with a first drive speed, in accordance with instructions provided by the processor to the actuator and that are implemented by the actuator in automatically closing the door, when the counter is less than a predetermined threshold; and
automatically closing the door in accordance with a second protocol with a second driving force that is greater than the first driving force, and with a second drive speed that is greater than the first drive speed, in accordance with instructions provided by the processor to the actuator and that are implemented by the actuator in automatically closing the door, when the counter is greater than a predetermined threshold.

20. The vehicle of claim 19, wherein the processor is further configured to at least facilitate, upon receiving the input for closing the door:
automatically closing the door with the first drive speed, wherein the first drive speed is based on a first function of drive speed versus closing distance between the door and the seal, and wherein the first function includes increasing values of drive speed versus the closing distance, in accordance with instructions provided by the processor, when the counter is less than the predetermined threshold; and
automatically closing the door with the second drive speed, wherein the second drive speed is greater than the first drive speed, and wherein the second drive speed is based on a second function of drive speed versus closing distance between the door and the seal, wherein the second function includes increasing values of drive speed versus the closing distance, and wherein the second function comprises an upward vertical shift of the first function, in accordance with instructions provided by the processor, when the counter is greater than the predetermined threshold.
